(19) United States
(12) Patent Application Publication
(10) Pub. No.: US 2005/0077184 A1
(43) Pub. Date: Apr. 14, 2005

(54) Method for preparing surface for obtaining surface-enhanced Raman scattering spectra of organic compounds

(75) Inventors: Rem M. Lazarenko-Manevich, Obninsk (RU); Victor V. Nekrasov, Moscow (RU); Yevgeny B. Brik, Obninsk (RU); Vladimir R. Lazarenko-Manevich, Moscow (RU); Igor V. Fetisov, Moscow (RU); Oleg Lagutenko, Aventura, FL (US)

Correspondence Address: BROWDY AND NEIMARK, P.L.L.C.;624 NINTH STREET, NW, SUITE 300, WASHINGTON, DC, 20001-5303, US

(73) Assignee: Organotek Defense System Corporation, Aventura, FL (US)

(21) Appl. No.: 10/681,263

(22) Filed: Oct. 9, 2003

(51) Int. Cl. C25D 5/18; C25D 11/20; G01N 27/26

(52) U.S. Cl. 205/105; 205/173; 205/787

(57) ABSTRACT

A surface-enhanced Raman scattering surface is prepared by anodizing an aluminum or aluminum alloy substrate with reversed polarity current to form pores of anodized oxide on the substrate, and electrodepositing silver or copper into the pores of the anodic oxide film to form needle-shaped metal particles in the pores of the anodic oxide film.

### FIELD OF THE INVENTION

The present invention relates to analytical spectroscopy and, more particularly, to surfaces useful for enhancing Raman spectra of organic compounds.

### BACKGROUND OF THE INVENTION

Analyzing trace organic contaminants in natural waters and purified waste waters requires constant improvement of existing analytical methods, as well as the development of new methods based on implementation of newly evolved concepts. Much of this requirement is linked to the development of new compounds, either synthesized by industry or produced by industrial processes as waste, which may be undesirable or even dangerous. There is also a constant increase in the rigor of demands for increasingly sensitive analytic methods for traditional environmental pollutants, brought about by the growing encroachment of modern civilization on natural plant and biological systems.

In 1928, C. V. Raman discovered that when certain molecules are illuminated, a small percentage of the molecules which have retained a photon do not return to their original vibrational level after remitting the retained photon, but drop to a different vibrational level of the ground electronic state. Radiation emitted from these molecules will therefore be at a different energy and hence a different wavelength. This is referred to as Raman scattering.

A significant increase in the intensity of Raman light scattering can be observed when molecules are brought into close proximity to (but not necessarily in contact with) certain metal surfaces. The metal surfaces must be “roughened”, or coated with minute metal particles. This is called Surface Enhanced Raman Scattering (SERS).

The cause of the SERS effect is not completely understood. However, current thinking envisions at least two separate factors contributing to SERS. First the metal surface contains minute irregularities. These irregularities can be thought of as spheres. Those particles with diameters of approximately 1/10^{th} the wavelength of the incident light are considered to contribute most to the effect. The incident photons induce a field across the particles which, being metal, have very mobile electrons.

In certain configurations of metal surfaces or particles, groups of surface electrons can be made to oscillate in a collective fashion in response to an applied oscillating electromagnetic field. Such a group of collectively oscillating electrons is called a “plasmon.” The incident photons supply this oscillating electromagnetic field. The induction of an oscillating dipole moment in a molecule by incident light is the source of the Raman scattering. The effect of the resonant oscillation of the surface plasmons is to cause a large increase in the electromagnetic field strength in the vicinity of the metal surface. This results in the enhancement of the oscillating dipole induced in the scattering molecule and hence increase the intensity of the Raman scattered light. The effect is to increase the apparent intensity of the incident light in the vicinity of the particles.

A second factor considered to contribute to the SERS effect is molecular imaging. A molecule with a dipole moment which is in close proximity to a metallic surface will induce an image of itself on that surface of opposite polarity (i.e., a “shadow” dipole on the plasmon). The proximity of that image is thought to enhance the power of the molecules to scatter light. Put another way, this coupling of a molecule having an induced or distorted dipole moment to the surface plasmons greatly enhances the excitation probability. The result is a very large increase in the efficiency of Raman light scattered by the surface-adsorbed molecules.

Surface Enhanced Raman Spectroscopy is one of the most highly sensitive methods for analyzing extremely small traces of organic compounds in water, air and biological particles. According to the literature (Kneipp et al., 1999), this makes it possible in some cases to detect single molecules of analytes. SERS enhances the Raman cross-section of the molecule by more than six orders of magnitude when the molecule is adsorbed from aqueous or gaseous media onto the rough surfaces of silver, copper, or gold, as well as on the sol particles of these metals.

Ever since the discovery of SERS, many ways of forming SERS-active surfaces of the above-mentioned metals have been developed, including a number of ways for electrochemically roughening the electrode surface (Marinyuk et al., 1982; Fleischmann et al., 1984), vacuum deposition of gold or silver island films (Ritchie et al., 1984) and “cold” silver films (Otto, 1984), microlithographic formation of “bar” structures on silver (Liao, 1984), creation of optimally sized microspheres by depositing silver onto polymeric spherical particles (Szabo et al., 1997), and depositing silver sol particles onto an inert polymeric matrix (Vo-Dinh, 1987). The search for new ways for creating SERS-active metal surfaces has been and remains one of the principal directions in the development of new analytical methodologies based on SER spectroscopy (Lyon et al., 1998).

Many ways of creating SERS-active surfaces of silver, copper, and gold have been suggested, including obtaining “needle-shaped” structures on silver by microlithography (Liao, 1984), as well as the creation of “spiked” silver structures in the nuclear filter pores (Koudelina et al., 1991). The SERS-active needle-shaped metal surface significantly (up to 2-3 orders of magnitude) enhances the electrical filed of a light wave on the surfaces of needle-shaped silver or copper structures when the localized plasmons are optically excited in these structures. The high curvature surface areas (the tips of the metal needles) enhances a “lightning rod” effect, in which the electrical field is concentrated at the metal tips. As a result of this electromagnetic enhancement, there is a drastic increase in the intensity of the Raman scattering of light by molecules located on or near the surface of the needle-shaped metal particles. The Raman spectrum enhancement coefficient at adsorption of the molecules being analyzed on the particles depends on the diameter and length of a metal particle as well as on its dielectric permittivity in the operational range of the light frequencies.

To create needle-shaped structures, silver is vacuum deposited onto dielectric substrates containing bumps (Liao, 1984) or pores (Koudelina et al., 1991) having the required sizes. The common drawback to all methods for obtaining SERS-active surfaces, which hampers their use for quantitative analysis, is instability of the surface structure, which can be attributed to various physical and chemical processes. For instance, oxidation of silver, sulfide formation, adsorption of products of a possible decomposition of the analyzed substance, slow annealing of points, and larger scale surface defects. In particular, when using vacuum deposition, it is not always possible to ensure a satisfactory and durable adhesion between the film and the substrate. Additionally, there are no simple and reliable ways to restore the SERS activity of surfaces after the damaging effects without any danger to the film.

The method of obtaining a surface for identification of molecular structure and ingredients of a substance using SERS spectroscopy (Koudelina et al., 1991) has been considered. This method consists of creating spiked metal structures in the nuclear filter pores by spraying a flow of silver atoms onto the surface of a rotating filter in an inclined position. While ensuring a higher sensitivity of measurements when obtaining SERS spectra of various compounds, this structure has a number of drawbacks, as follows: complicated procedure for producing the filter substrate by irradiating a polymer film in a nuclear reactor or in a heavy ion accelerator, etching the film and cleaning off the etching traces from it, and difficulty in producing the spiked silver structure proper by vacuum evaporation of silver onto the filter. There is a lack of data on reproducibility of features of an active surface and on the stability of the silver coating when used for repeated analyses. So far, this structure has been found suitable for merely qualitative identification of the nature of a compound, but not for quantitative analysis.

Thus, the stability of SERS-active structures remains a major problem in analytical SERS spectroscopy, which so far has had no satisfactory solution.

### SUMMARY OF THE INVENTION

It is an object of the present invention to overcome the aforesaid deficiencies in the prior art.

It is a further object of the present invention to provide improved surfaces for use in SERS spectroscopy.

It is another object of the present invention to provide a method for making improved surfaces for use in SERS spectroscopy.

The present invention uses specific structural features of anodic oxide films on aluminum and its alloys in SERS spectroscopy. Because of the electrochemical characteristics of aluminum, porous oxide films are formed in the process of anodizing aluminum. The diameter of the pores formed, about 10 to about 40 nm, and the fact that the pores are oriented normally to the film surface, proves to be optimal for the needle-shaped silver, copper, or gold particles required for the SERS effect. The depth of the pores, about 0.1 to about 2 microns and above, and concentration of the pores, up to about 10¹⁰ per cm², are easily controlled by the anodic current density, anodizing period (from seconds to tens of minutes) and the electrolyte composition (Sinyavsky, 1979). Electrodeposition of silver or copper in the pores of oxide films during anodizing aluminum and its alloys with the reversed polarity current in solution containing salts of silver and/or copper creates a system of metal “needles” immersed in the oxide, which needles have the required size for obtaining SERS spectra.

The mechanical, thermal and chemical stability of the needle-shaped structures formed by the present invention is high, and this is used to produce a durable coating of construction-used items made of aluminum and its alloys and designed for operation in the open air and under atmospheric precipitation conditions.

To periodically clean a SERS-active surface in the case of its possible contamination with various strongly adsorbed substances, the surface is brought into contact with an anodizing solution containing salts of silver or copper and subjected to repeated anodizing in the above-described polarization mode for as long as required to remove the contaminants. After the unwanted adsorbates are removed and the surface is flushed with water, the SERS activity of the surface is restored.

### DETAILED DESCRIPTION OF THE INVENTION

The Surface-Enhanced Raman Scattering (SERS) surfaces of the present invention can be used to quantify organic compounds adsorbed from air or water or other fluids on the SERS-active surface which has needle-shaped metal particles. The SERS-active surfaces are prepared from anodized aluminum or anodized aluminum alloys are used as the SERS-active surface and needle-shaped metal particles are formed by electrodeposition of silver or copper into the pores of the anodic oxide film. The anodized aluminum or aluminum alloy film is produced by anodizing aluminum or an aluminum alloy with reversed polarity current in solution containing salts of silver.

In another embodiment of the present invention, the needle-shaped metal particles are formed by electrodepositing copper in the pores of an anodic oxide film produced by anodizing aluminum or an aluminum alloy with reversed polarity current in solutions containing salts of copper.

In order to clean surfaces on which substances are irreversibly adsorbed, these substances being contaminants from the fluid treated which have formed during the adsorption process, a SERS-active surface according to the present invention is subjected to periodic anodizing using reversed polarity. For this purpose, a required quantity of a silver or a copper solution is poured into a cell. For a few seconds the pulsed current of reversed polarity and of required value is fed between a SERS-active surface and an auxiliary silver or copper electrode. After this, the solution is drained from the cell and the cell is filled with flushing water or another flushing solvent. After this is drained, the surface is dried with a flow of clean air or another gas, such as nitrogen. The cell is then filled with the liquid or gaseous compound to be assayed.

In an analysis according to the present invention, an analyte is adsorbed onto the needle-like metal particles of the substrate. A radiation source is selected to generate radiation having a wavelength that causes appreciable Raman scattering in the presence of the analyte being measured. Although it is known that Raman scattering occurs at all wavelengths, typically, the radiation employed will be near infrared radiation, since ultraviolet radiation often causes fluorescence.

A radiation detector is provided to detect the scattered radiation emitted from the surface of the substrate.

The assays of the present invention preferably use optical sources that produce radiation having multiple wavelengths and one or more detectors for reading the reflected signal. The detectors can incorporate filters of beam splitters to separate the different wavelength components in the radiation. Alternatively, the optical sources can comprise multiple radiation sources each producing radiation of a single wavelength and the radiation sources are activated sequentially. For any particular analyte, selection of specific multiple wavelength radiation where desired can be accomplished by standard mathematical techniques such as chemometric or statistical analysis.

As used in the present invention, the term “aluminum alloy” refers to an alloy containing about 90% or more aluminum, and one or more alloying elements. Alloying can be used to improve mechanical performance. The preferred alloying elements are magnesium, usually comprising about 0.5 to about 01% by weight of the alloy, and manganese, usually provided at about 0.15 to about 2 weight percent of the total alloy. Other suitable aluminum alloys include aluminum-copper, which includes 4.4% copper, 1.5% magnesium, 0.6% manganese, and the remainder aluminum.

Other aluminum alloys for use in the present invention include alloys of aluminum with iron, silicon, chromium, lead, magnesium, copper, zinc, lithium as binary, ternary, or quaternary alloys. One skilled in the art can readily determine which aluminum alloys are most suitable for SERS active surfaces.

The foregoing description of the specific embodiments will so fully reveal the general nature of the invention that others can, by applying current knowledge, readily modify and/or adapt for various application such specific embodiments without undue experimentation and without departing from the generic concept. Therefore, such adaptations and modifications should and are intended to be comprehended within the meaning and range of equivalents of the disclosed embodiments.

It is to be understood that the phraseology or terminology employed herein is for the purpose of description and not of limitation. The means and materials for carrying out various disclosed functions may take a variety of alternative forms without departing from the invention.

Thus, the expressions “means to . . . ” and “means for . . . ” as may be found in the specification above and/or in the claims below, followed by a functional statement, are intended to define and cover whatever structural, physical, chemical, or electrical element or structures which may now or in the future exist for carrying out the recited function, whether or nor precisely equivalent to the embodiment or embodiments disclosed in the specification above. It is intended that such expressions be given their broadest interpretation.

### REFERENCES

1. Kneipp K., Kneipp H., Itzkan I., Dasari R. R., Feld M. S. Chem. Rev. 1999. V.99. P.2957.
2. Marinyuk V. V., Lazorenko-Manevich R. M., Kolotyrkin Ya. M. Adv. Phys. Chem. Current Developments in Electrochemistry and Corrosion.—Ed. by Ya. M. Kolotyrkin.—Moscow: MIR Publishers, 1982. P.148.
3. Fleischmann M., Hill I. R. Surface Enhanced Raman Scattering.—Ed. by R. Chang and T. Furtak. New york&London: Plenum Press, 1982. P.275.
4. Ritchie G., Chen S. I. Surface Enhanced Raman Scattering.—Ed. by R. Chang and T. Furtak. New york&London: Plenum Press, 1982.P.354.
5. Otto A. Light Scattering in Solids. Vol.4.—Ed. by M. Cardona and G. Guntherodt.—Berlin: Springer, 1984. P.289.
6. Liao R. F. Surface Enhanced Raman Scattering.—Ed. by R. Chang and T. Furtak. New york&London: Plenum Press, 1982. P.379.
7. Szabo N. J., Winefordner J. D. Anal. Chem. 1997. V.69. P.2418.
8. Vo-Dinh T. U.S. Pat. No. 4,674,878, 1987.
9. Lyon, L. A.; Keating C. D.; Fox A. P.; Baker B. E.; Lin He, Nicewarner S. R., Mulvaney S. P.; Natan M. J. Anal. Chem. 1998, 70, 341R.
10. Koudelina I. A., Kuznecov V. I., Mchedlishvili B. V., Nabiev I. R., Olejnikov V. A., Sokolov K. V., Shestakov V. D. Patent USSR SU No 1673929 A1. 1991. Bjul. No 32.
11. Sinyavsky et al., Corrosion and Protection of Aluminium Alloys Moscow, Metallurguiya Publishers, 1979, 224 P.

1. A method for preparing a surface-enhanced Raman scattering surface comprising anodizing an aluminum or aluminum alloy substrate with reversed polarity current to form pores of anodized oxide on the substrate, and electrodepositing silver or copper into the pores of the anodic oxide film.

2. The method according to claim 1 wherein the pores have a diameter of from about 10 to about 40 nm.

3. The method according to claim 1 wherein the depth of the pores is from about 0.1 to about 2 microns.

4. The method according to claim 1 wherein the concentration of the pores on the substrate is up to about 10¹⁰ per cm².

5. A surface for use in Surface-Enhanced Raman Scattering comprising a substrate made of anodized aluminum or anodized aluminum alloy onto which silver or copper has been electrodeposited to form needle-shaped metal particles on the substrate.

6. The surface according to claim 5 wherein the pores have a diameter of from about 10 to about 40 nm.

7. The surface according to claim 5 wherein the depth of the pores is from about 0.1 to about 2 microns.

8. The surface according to claim 5 wherein the concentration of the pores on the substrate is up to about 10¹⁰ per cm².

9. A method for cleaning the substrate according to claim 1 comprising adding a copper or a silver solution into a cell and applying a pulsed current of reversed polarity to a SERS-active surface and an auxiliary silver or copper electrode;
Draining the solution from the cell and flushing the cell; and
Draining and drying the surface of the substrate.

10. In a method for detecting an organic compound analyte in a sample by Surface Enhanced Raman Spectroscopy, the improvement comprising using as an electrode the surface of claim 1.

11. The method according to claim 10 wherein the surface contains copper particles.

12. The method according to claim 11 wherein the surface contains silver particles.
